(19) United States
(12) Patent Application Publication
(10) Pub. No.: US 2009/0073982 A1
(43) Pub. Date: Mar. 19, 2009

(54) TCP PACKET COMMUNICATION DEVICE AND TECHNIQUES RELATED THERETO

(76) Inventors: Yohei Kaneko, Kyoto (JP); Atsuhiro Tsuji, Osaka (JP)

Correspondence Address: MCDERMOTT WILL & EMERY LLP, 600 13TH STREET, NW, WASHINGTON, DC, 20005-3096, US

(21) Appl. No.: 12/209,595

(22) Filed: Sep. 12, 2008

(30) Foreign Application Priority Data
Sep. 19, 2007 (JP) 2007-242141

(51) Int. Cl. H04L 12/56

(52) U.S. Cl. 370/392

(57) ABSTRACT

A protocol processing unit processes a packet used for connection establishment according to TCP/IP based on management information on the connection establishment and processes a packet used for payload transmission. A payload packet transmission/reception processing unit having a hardware configuration performs transmission/reception processing on the packet used for the payload transmission based on the management information. A connection synchronization processing unit performs synchronization processing for synchronizing the management information held by the protocol processing unit with the management information held by the payload packet transmission/reception processing unit.

### BACKGROUND OF THE INVENTION

1. Field of the Invention

The present invention relates to a TCP (Transmission Control Protocol) packet communication device performing synchronization processing on management information according to a TCP, and to a video receiver and a data accumulation device related to the TCP packet communication device.

2. Description of the Related Art

As a conventional TCP packet communication device, there is known a TCP packet communication device including a low-speed processing communication adapter executing only communication protocol processing of lower layers related to control over network transmission paths and a high-speed processing communication adapter executing communication protocol processing of not only lower layers but also upper layers. A TCP packet communication device of this type is disclosed in, for example, Japanese Patent Application Laid-Open No. 6-309251. In the TCP packet communication device disclosed in the Japanese Patent Application Laid-Open No. 6-309251, the low-speed processing communication adapter performs TCP/IP processing as a software program and the high-speed processing communication adapter performs TCP/IP processing by additionally including a TCP/IP processing device.

The conventional TCP packet communication device is confronted with the following situations.

(a) To realize the high-speed communication adapter, the packet processing for TCP connection establishment/termination requires a complicated algorithm. Further, it is highly likely that up-to-date versions of the algorithm are proposed in the future. Therefore, to incorporate the high-speed communication adapter into the TCP packet communication device as hardware has a high risk of resulting in lack of interoperability and also lead to a legacy problem. The “legacy problem” means a need to cope with tendencies to eliminate old-fashioned technical elements, to simplify design, to cut manufacturing cost, and to realize space saving.

(b) Because of the reason (a), to realize the high-speed processing communication adapter as hardware has a high risk. Due to this, it is necessary for the high-speed processing communication adapter to include a dedicated CPU (central processing unit) and to perform high-speed processing through a software program.

(c) According to conventionally used network technologies, a communication adapter is incorporated on the basis of the presence of a powerful CPU in PC architecture. It is, therefore, less necessary to make such approaches as described in (a) and (b) above. However, in the situation in which demand for complying with household transmission standards typified by recent DLNA (Digital Living Network Alliance) grows, the necessity for networking home electric appliance increases. As a result, there is an increasing necessity to solve the tradeoff between the restriction on CPU resources and cost restriction in relation to home electric appliances and the performance for handling high-definition and large-capacity video data.

In these situations, the following problems occur.

(A) It is necessary to install a CPU dedicated to the high-speed processing communication adapter, resulting in cost increase.
(B) Various types of software are used to perform packet processing for TCP connection establishment/termination. It is difficult to verify whether those types of software are appropriate for the update and quality guarantee of the algorithm.
(C) To solve the problems (A) and (B), there may be proposed a technique for performing packet processing for the TCP connection establishment/termination accompanied by a complicated algorithm by means of the low-speed processing communication adapter and for performing packet processing for transmission of payload including video data or the like by means of the high-speed processing communication adapter. With this technique, however, it is disadvantageously necessary to secure a mechanism for sharing TCP management information necessary when generating TCP packets and conducting TCP packet reception check between these two communication adapters so that the two communication adapters can handle TCP packets.

### SUMMARY OF THE INVENTION

It is, therefore, a main object of the present invention to provide a TCP packet communication device capable of reducing cost by dispensing with a CPU dedicated to a high-speed processing communication adapter and of reducing an amount of software for packet processing for TCP connection establishment/disconnection.

(1) A TCP packet communication device according to one aspect of the present invention includes:

a protocol processing unit for processing a packet used for connection establishment according to TCP/IP based on management information on the connection establishment, and processing a packet used for payload transmission;

a payload packet transmission/reception processing unit having a hardware configuration for performing transmission/reception processing on the packet used for the payload transmission based on the management information; and

a connection synchronization processing unit for performing synchronization processing on the management information in the protocol processing unit based on an instruction from the payload packet transmission/reception processing unit.

Namely, the TCP packet communication device according to one aspect of the present invention is configured to separately provide the protocol processing unit (corresponding to the low-speed processing communication adapter) and the payload packet transmission/reception processing unit (corresponding to the high-speed processing communication adapter), and to provide the connection synchronization processing unit for associating both the units to each other.

With this configuration, the communication adapter is divided into the protocol processing unit for the low-speed processing and the payload packet transmission/reception processing unit for the high-speed processing. However, the connection synchronization processing unit associates the protocol processing unit with the payload packet transmission/reception processing unit, and performs management information synchronization processing on the protocol processing unit in response to an instruction from the payload packet transmission/reception processing unit. Therefore, TCP packets can be generated and reception check can be conducted without hindrance. Besides, the protocol processing unit for the low-speed processing performs packet processing for complicated TCP connection establishment/termination. This configuration, therefore, dispenses with a CPU and software dedicated to the payload packet transmission/reception processing unit for the high speed processing and makes it possible to cut cost.

(2) With the configuration (1), the connection synchronization processing unit may further include a management information update unit for directly updating the management information in the protocol processing unit. When thus configured, it is possible to minimize the load of software used for updating the management information.

(3) With the configuration (2), the connection synchronization processing unit may further include a first update indicator for setting an update timing of the management information at regular intervals, and

the management information update unit updates the management information at the update timing set by the first update indicator. When thus configured, it is possible to freely control the load imposed by the management information synchronization processing.

(4) With the configuration (2), the connection synchronization processing unit may further include a second update indicator for setting an update timing of the management information whenever a packet is received, and

the management information update unit updates the management information at the update timing set by the second update indicator. When thus configured, it is possible to place emphasis on real time performance of the management information synchronization processing.

(5) With the configuration (2), the connection synchronization processing unit may further include a third update indicator for setting an update timing of the management information whenever one of a FIN packet and an RST packet is received, and

the management information update unit updates the management information at the update timing set by the third update indicator. When thus configured, the management information can be updated only at minimum required timing.

(6) With the configuration (1), the connection synchronization processing unit may further include

a connection packet monitoring unit for acquiring information necessary for the synchronization processing on the management information by referring to a content of each of the packets input to the protocol processing unit; and

a connection packet generator for altering each of the packets output from the protocol processing unit by referring to the information acquired by the connection packet monitoring unit. When thus configured, the existing unit can be used as the protocol processing unit.

(7) With the configuration (6), the connection synchronization processing unit may further include a first generation indicator for setting a packet alteration timing of the connection packet generator at intervals of packet reception, and

the connection packet generator alters the output packet at the packet alteration timing set by the first generation indicator. When thus configured, it is possible to place emphasis on real time performance of the management information synchronization processing.

(8) With the configuration (6), the connection synchronization processing unit may further include a second generation indicator for setting a packet alteration timing of the connection packet generator whenever the output packet has a specific data size, and

the connection packet generator alters the output packet at the packet alteration timing set by the second generation indicator. When thus configured, the frequency of the management information synchronization processing can be interlocked with a band corresponding to a line speed.

(9) With the configuration (6), the connection synchronization processing unit may further include a third generation indicator for setting a packet alteration timing of the connection packet generator at predetermined time intervals, and

the connection packet generator alters the output packet at the packet alteration timing set by the third generation indicator. When thus configured, it is possible to freely control cyclic load imposed by the management information synchronization processing.

(10) With the configuration (1), the TCP packet communication device may further include a buffer management information update unit for fetching a packet used for the payload transmission from the payload packet transmission/reception processing unit, directly supplying the packet used for the payload transmission to an internal buffer of the protocol processing unit, and updating the management information, and

the protocol processing unit performs a packet processing using an ordinary interface. When thus configured, existing application can be used for the protocol processing unit.

(11) A video receiver according to another aspect of the present invention includes

the TCP packet communication device according to (1); and

a codec processing unit for compressing and decompressing video data and voice data, wherein

the packet processed by the payload packet transmission/reception processing unit and used for the payload transmission is directly input to the codec processing unit. According to this configuration, a video receiver having the characteristics of (1) such as a television can be obtained.

(12) A data accumulation device according to yet another aspect of the present invention includes

the TCP packet communication device according to (1); and

a data accumulation unit for accumulating video data and voice data, wherein

the packet processed by the payload packet transmission/reception processing unit and used for the payload transmission is directly input to the data accumulation unit. According to this configuration, a data accumulation device having the characteristics of (1) such as a hard disk recorder can be obtained.

The TCP packet communication device according to the present invention exhibits the following advantages.

(a) Since the protocol processing unit performs the packet processing for the complicated TCP connection establishment/termination, a CPU dedicated to the high-speed processing communication adapter is no longer necessary and the cost can be reduced.

(b) Since the packet processing for the TCP connection establishment/termination can be centralized in the protocol processing unit, software amount can be reduced and verifications for update and quality guarantee of the algorithm needs to be made only for a single protocol processing unit.

(c) The load imposed by the update of the management information can be reduced or adjusted according to the processing performance of the CPU and the system load state. Therefore, it is possible to improve real time performance for video processing and other application processing by a user interface or the like.

(d) Packet transmission using the management information can be performed whenever a predetermined data size is received. It is, therefore, possible to realize such functions as fast-forward replay or rewind replay of received video pictures.

(e) The load imposed by the update of the management information can be substantially eliminated. It is, therefore, possible to configure a portable receive-only device such as a portable television incorporating therein a relatively low-performance processor.

(f) Since the existing protocol processing unit can be used as the protocol processing unit, it is possible to shorten a work period for product development and reduce a period of time required for product verification.

By applying the present invention, it is possible to realize high speed TCP communication performance while minimizing alternation to existing resources of the existing device for TCP/IP communication and dispensing with a dedicated processor. Furthermore, it is possible to realize a device configured to be able to reduce system load so that even a low processor-capability terminal can be used together with the device according to purposes, a device configured to be able to place emphasis on real time performance so that a demand for a terminal including a user interface such as screen operation can be met, and a device configured to be able to exert special control such as fast-forward replay or rewind replay, while realizing both cost reduction and high-speed communication performance. The TCP communication device according to the present invention can be used as terminals compatible with various networks. Due to this, environments to which the present invention is applicable are not limited to televisions and hard disk recorders but the present invention can cover a variety of application ranges.

### BRIEF DESCRIPTION OF THE DRAWINGS

The above and other objects of the present invention will be readily apparent from embodiments to be described below and clarified by claims that follow. To carry out the present invention could remind persons skilled in the art of many benefits from the present invention not specified in this specification.

FIG. 1 is a block diagram showing a configuration of a TCP packet communication device according to First Embodiment of the present invention;

FIG. 2 is a format diagram of a TCP packet;

FIG. 3 is a block diagram showing a configuration of a TCP packet communication device according to Second Embodiment of the present invention;

FIG. 4 is a block diagram showing a configuration of a TCP packet communication device according to Third Embodiment of the present invention;

FIG. 5 is a block diagram showing a configuration of a TCP packet communication device according to Fourth Embodiment of the present invention;

FIG. 6 is a block diagram showing a configuration of a TCP packet communication device according to Fifth Embodiment of the present invention; and

FIG. 7 is a block diagram showing a configuration of a TCP packet communication device according to Sixth Embodiment of the present invention.

### DETAILED DESCRIPTION OF THE INVENTION

Embodiments of the present invention will be described hereinafter with reference to the accompanying drawings.

### First Embodiment

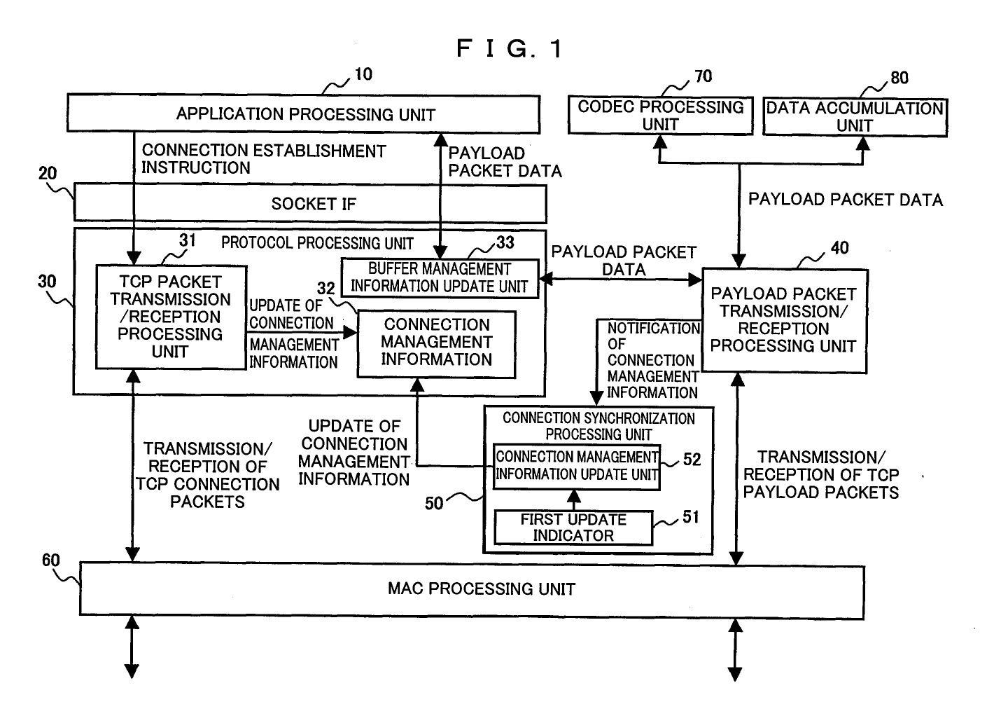

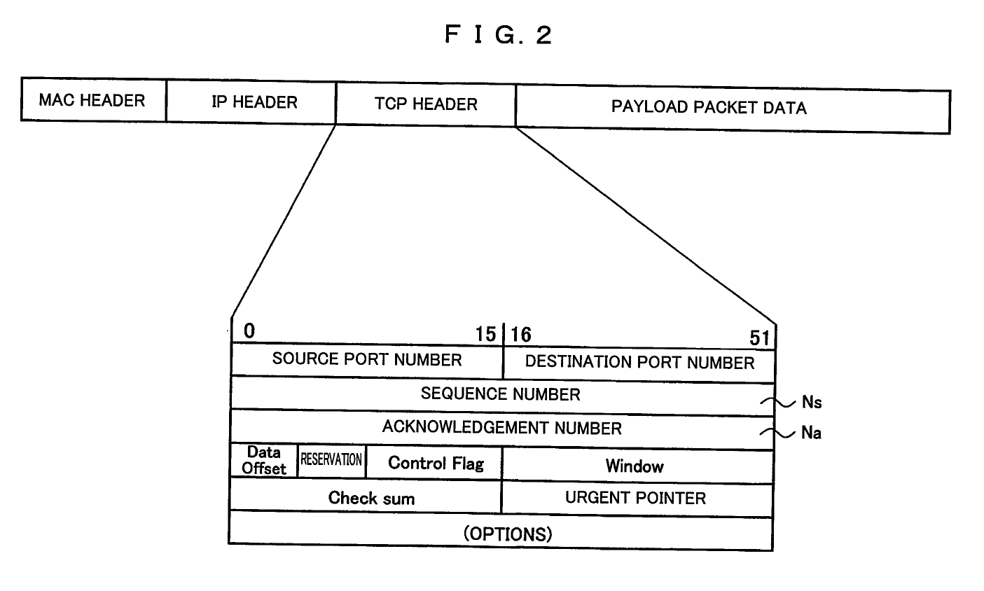

FIG. 1 is a block diagram showing a configuration of a TCP packet communication device according to First Embodiment of the present invention. FIG. 2 is a format diagram of a TCP packet. In FIG. 1, reference symbol 10 denotes an application processing unit, reference symbol 20 denotes a socket interface (IF), and reference symbol 30 denotes a protocol processing unit including a TCP packet transmission/reception processing unit 31, connection management information (connection establishment management information) 32, and a buffer management information update unit 33. Reference symbol 40 denotes a payload packet transmission/reception processing unit, and reference symbol 50 denotes a connection synchronization processing unit including a first update indicator 51 and a connection management information update unit 52. Reference symbol 60 denotes a MAC (Media Access Control) processing unit, reference symbol 70 denotes a codec processing unit, and reference symbol 80 denotes a data accumulation unit. In the following embodiments including First Embodiment, the connection management information 32 corresponds to connection establishment management information.

The application processing unit 10 transmits a connection establishment instruction to the TCP packet transmission/reception processing unit 31 via the socket IF 20. The application processing unit 10 also receives payload packet data from the buffer management update unit 33 via the socket IF 20. The TCP packet transmission/reception processing unit 31 establishes a TCP connection. Namely, the TCP packet transmission/reception processing unit 31 transmits or receives packets to or from a electronic device on the other end. For example, the transmission/reception processing unit 31 generates packets necessary for establishment of the TCP connection and transmits the generated packets to the electronic device on the other end through the MAC processing unit 60. The TCP packet transmission/reception processing unit 31 generates TCP packets using the connection management information 32 (packet parameters) when communicating the TCP packets with the electronic device on the other end. After completion of the establishment of the TCP connection, the MAC processing unit 60 transfers all received packets in the TCP connection to the payload packet transmission/reception processing unit 40. The payload packet transmission/reception processing unit 40 notifies the connection synchronization processing unit 50 of a sequence number Ns indicating a sequence of each packet and an acknowledgment number NA of each packet by referring to TCP header information on the received packets. Furthermore, the payload packet transmission/reception processing unit 40 eliminates a TCP header from each packet, extracts only a payload part of each packet, and transfers payload packet data to the buffer management information update unit 33, the codec processing unit 70, and the data accumulation unit 80. The connection synchronization processing unit 50 always holds the latest sequence number Ns and the latest acknowledge number Na notified from the payload packet transmission/reception processing unit 40. The first update indicator 51 notifies the connection management information update unit 52 of update timing at preset time intervals. The connection management information update unit 52 overwrites the sequence number Na and the acknowledgment number Ns held in the connection management information 32 with the latest values, respectively. The buffer management information update unit 33 holds payload packet data received from the payload packet transmission/reception processing unit 40. Further, the buffer management information update unit 33 updates buffer management information and, if the application processing unit 10 is to fetch the payload packet data from each packet, acquires the payload packet data via the socket IF 20. The codec processing unit 70 performs compression/decompression processing suited for video or voice on the payload packet data received from the payload packet transmission/reception processing unit 40, and outputs the processed data to, for example, a display screen or a loudspeaker. The data accumulation unit 80 accumulates the payload packet data received from the payload packet transmission/reception processing unit 40 in a large-capacity storage device (not shown) such as a hard disk or a DVD.

Operation performed by the TCP packet communication device of the present embodiment configured as stated above will be described. If the application processing unit 10 transmits a connection establishment instruction to the TCP packet transmission/reception processing unit 31, the TCP packet transmission/reception processing unit 31 receiving the connection establishment instruction generates packets necessary to establish a TCP connection and transmits and receives packets to or from the electronic device on the other end via the MAC processing unit 60 so as to try establishing the TCP connection. At this time, the TCP packet transmission/reception processing unit 31 performs update processing on the sequence number Ns and the acknowledgment number Ns in the connection management information 32 by referring to the TCP header information on each TCP packet whenever receiving a TCP packet. The connection management information 32 thus sequentially updated serves as necessary information to generate a TCP packet next time.

After completion of the establishment of the TCP connection, the MAC processing unit 60 transfers all the received TCP packets in the TCP connection to the payload packet transmission/reception processing unit 40. The payload packet transmission/reception processing unit 40 notifies the connection synchronization processing unit 50 of the sequence number Ns and the acknowledgement number Na of each of the received packets by referring to the TCP header information on each of the received packets. Next, the payload packet transmission/reception processing unit 40 extracts a payload part from the TCP header of each of the received packets and eliminates the remainder of the TCP header. Further, the payload packet transmission/reception processing unit 40 transfers the payload packet data to the buffer management information update unit 33, the codec processing unit 70, and the data accumulation unit 80.

The connection synchronization processing unit 50 always holds the latest sequence number Ns and the latest acknowledgement number Na of each of the received packets notified from the payload packet transmission/reception processing unit 40. In this case, the first update indicator 51 notifies the connection management information update unit 52 of the update timing at preset time intervals. The connection management information update unit 52 receiving the notification of the timing overwrites the sequence number Ns and the acknowledgement number Na of each of the received packets held in the connection management information 32 with latest values, respectively. As a result, the buffer management information update unit 33 holds the payload packet data received from the payload transmission/reception processing unit 40. Furthermore, the application processing unit 10 acquires the payload packet data from the buffer management information update unit 33 via the socket IF 20 if the application processing unit 10 is to fetch the payload packet data. The application processing unit 10 can thereby holds high speed communication via the payload packet transmission/reception processing unit 40 while keeping a manner of calling the socket IF 20 (a manner without alternation).

The codec processing unit 70 performs the compression/decompression processing suited for video or voice on the payload packet data received from the payload packet transmission/reception processing unit 40, and outputs the processed data to, for example, the display screen or the loudspeaker. The data accumulation unit 80 accumulates the payload packet data received from the payload packet transmission/reception processing unit 40 in the large-capacity storage device such as a hard disk or a DVD.

In First Embodiment, constituent elements for transferring the payload packet data are the buffer management information update unit 33, the codec processing unit 70, and the data accumulation unit 80. Alternatively, the TCP packet communication device may include only one of or two out of these three constituent elements.

The TCP packet communication device according to First Embodiment exhibits the following advantages. The protocol processing unit 30 substantially similar to an existing protocol processing unit executes the complicated connection processing. Due to this, there is no need to install a high-speed transmission dedicated processor in the payload packet transmission/reception processing unit 40. It is, therefore, possible to reduce cost and realize high speed TCP transmission.

In First Embodiment, after the establishment of the TCP connection, the TCP communication is mainly executed by the payload packet transmission/reception processing unit 40. Due to this, the update of the connection management information 32 is made outside of the protocol processing unit 30 and the update timing is indicated by the first update indicator 51 at predetermined time intervals. It is, therefore, possible to reduce or adjust load accompanied by the update of the management information 32 according to a processing performance of the processor and a system load state. This can improve real time performance for video processing and other application processing by a user interface or the like.

### Second Embodiment

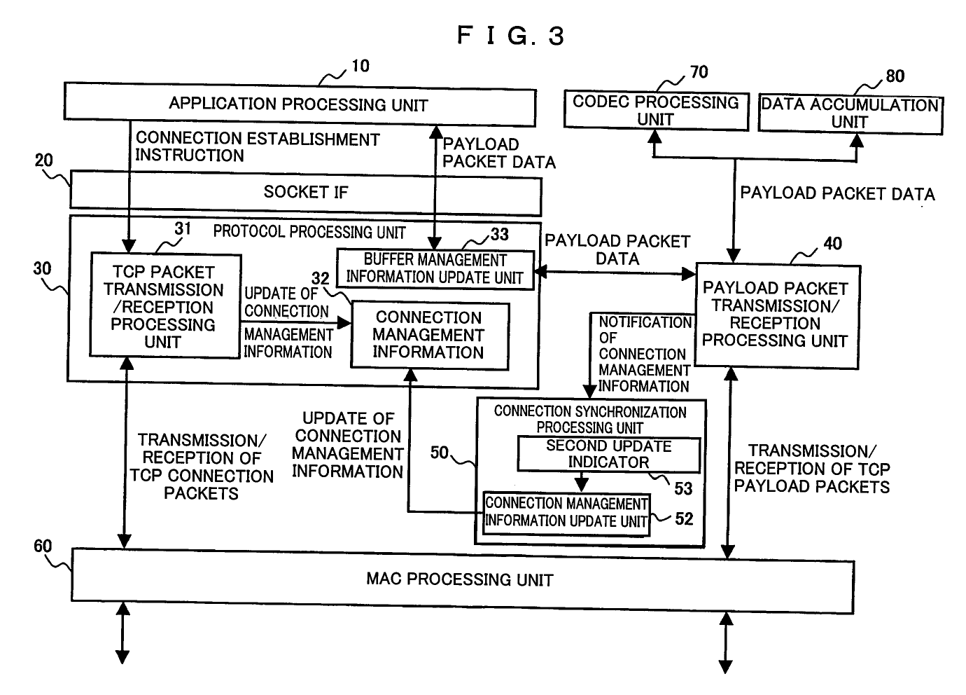

FIG. 3 is a block diagram showing a configuration of a TCP packet communication device according to Second Embodiment of the present invention. In FIG. 3, the same reference symbols as those shown in FIG. 1 (First Embodiment) denote the same constituent elements as those shown in FIG. 1, respectively. The TCP packet communication device according to Second Embodiment characteristically includes a second update indicator 53. The TCP packet communication device according to Second Embodiment does not include the first update indicator 51 shown in FIG. 1. The second update indicator 53 notifies the connection management information update unit 52 of update timing whenever the payload packet transmission/reception processing unit 40 notifies the connection synchronization processing unit 50 of management information (whenever the payload packet transmission/reception processing unit 40 receives a TCP packet). Since the other configurations of the TCP packet communication device according to Second Embodiment are similar to those according to First Embodiment, they will not be described herein.

As compared with First Embodiment, Second Embodiment exhibits the following characteristic advantages. The second update indicator 53 notifies the update timing of updating the connection management information 32 whenever a packet communication is held. Due to this, consistency is always kept between the received packet and the information held in the connection management information 32. As a result, the application processing unit 10 can any time transmit management information packets via the protocol processing unit 30 through the socket IF 20. The TCP packet communication device according to Second Embodiment characterized as stated above is suited for use as, for example, a device performing fast-forward replay or rewind replay of received video pictures.

### Third Embodiment

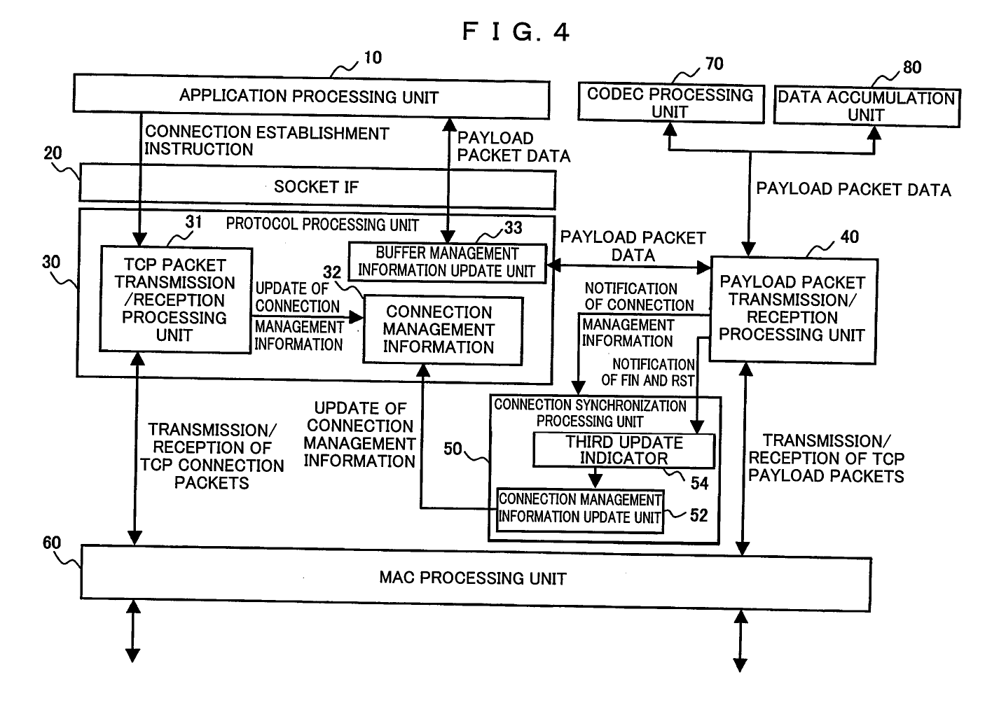

FIG. 4 is a block diagram showing a configuration of a TCP packet communication device according to Third Embodiment of the present invention. In FIG. 4, the same reference symbols as those in FIG. 1 (First Embodiment) denote the same constituent elements as those shown in FIG. 1, respectively. The TCP packet communication device according to Third Embodiment is characterized by further including a third update indicator 54. The third update indicator 54 notifies the connection management information update unit 52 of update timing of updating the connection management information 32 if receiving from the payload packet transmission/reception processing unit 40 a notification indicating reception of one of:

A FIN packet for terminating the TCP connection, and

An RST packet for resetting during detection of abnormality. Since the other configurations of the TCP packet communication device according to Third Embodiment are similar to those according to First Embodiment, they will not be described herein.

As compared with First Embodiment, Third Embodiment exhibits the following characteristic advantages. The timing of updating the connection management information 32 is limited only to at a time of the termination of the TCP connection (at which time transmission of the payload packet data is completed by the third update indicator 54). Therefore, synchronization processing is not performed on the connection management information 32 while the payload packet transmission/reception processing unit 40 is receiving packets. Due to this, it is possible to completely eliminate load accompanied by the update of the connection management information 32 although a transmission processing via the socket IF 20 cannot be performed. As a result, the TCP communication device according to Third Embodiment is suited for use as a portable receive-only device such as a portable television incorporating therein a relatively low-performance processor.

### Fourth Embodiment

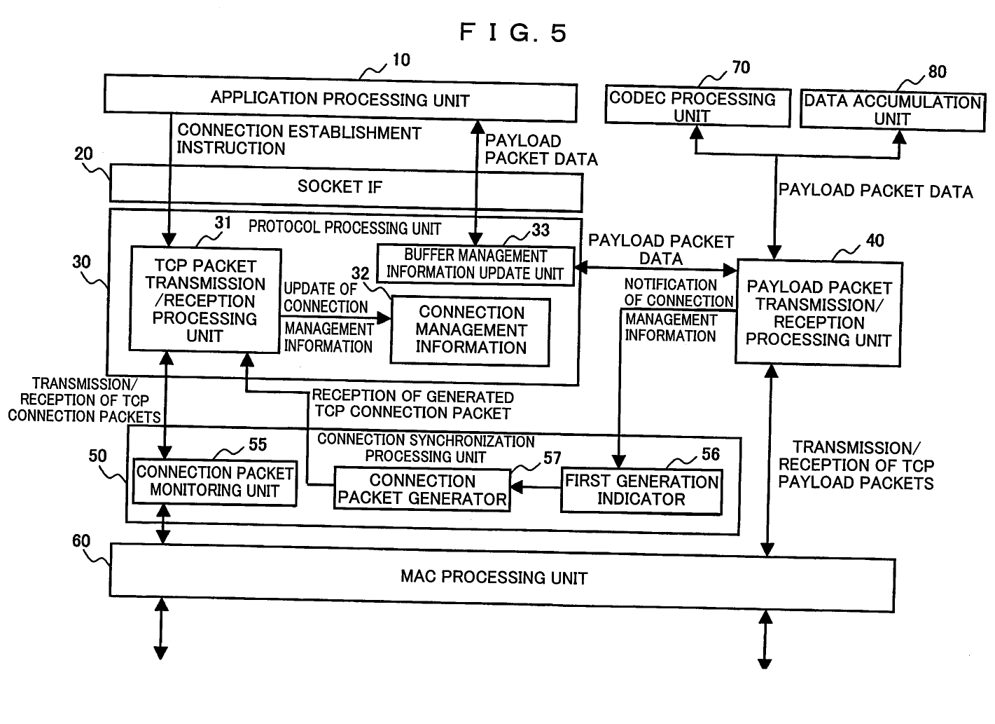

FIG. 5 is a block diagram showing a configuration of a TCP packet communication device according to Fourth Embodiment of the present invention. In FIG. 5, the same reference symbols as those in FIG. 1 (First Embodiment) denote the same constituent elements as those shown in FIG. 1, respectively. The TCP packet communication device according to Fourth Embodiment is characterized in that the connection synchronization processing unit 50 is configured to include a connection packet monitoring unit 55, a first generation indicator 56, and a connection packet generator 57. The connection monitoring unit 55 always refers to a content of each packet transmitted from the TCP packet transmission/reception processing unit 31 to the MAC processing unit 60. If the content of the packet referred to by the connection monitoring unit 55 indicates a TCP packet, the connection packet monitoring unit 55 always holds the latest updated values of the sequence number Ns and the acknowledgement number Na. The first generation indicator 56 notifies the connection packet generator 57 of update timing whenever the payload packet transmission/reception processing unit 40 notifies the connection synchronization processing unit 50 of management information (whenever the payload packet transmission/reception processing unit 40 receives a TCP packet). The connection packet generator 57 compares the acknowledgement number Na held by the connection packet monitoring unit 55 with the sequence number notified from the payload packet transmission/reception processing unit 40. If confirming that there is a difference between the acknowledgement number Na and the sequence number Ns, the connection packet generator 57 generates a TCP packet for synchronization processing on the connection management information 32. The “acknowledgement number held by the connection packet monitoring unit 55” is written in a sequence number Ns region and the “sequence number notified from the payload packet transmission/reception processing unit 40” is written in an acknowledgement number Na region in a parameter of the TCP packet which has been generated. By doing so, TCP header information consistent with a TCP packet which the TCP packet transmission/reception processing unit 31 has transmitted most recently is generated and then dummy payload packet data can be added. A length of the dummy payload packet data is set to correspond to the difference between the acknowledgement number Na held by the connection packet monitoring unit 55 and the sequence number Ns notified from the payload packet transmission/reception processing unit 40. The connection packet generator 57 transmits the TCP packet thus generated to the TCP packet transmission/reception processing unit 31. Since the other configurations of the TCP packet communication device according to Fourth Embodiment are similar to those according to First Embodiment, they will not be described herein.

Fourth Embodiment exhibits the following advantages. The protocol processing unit 30 can perform the synchronization processing on the connection management information 32 without altering an update configuration of the connection management information 32 and an algorithm change configuration in the existing protocol processing unit 30 at all.

### Fifth Embodiment

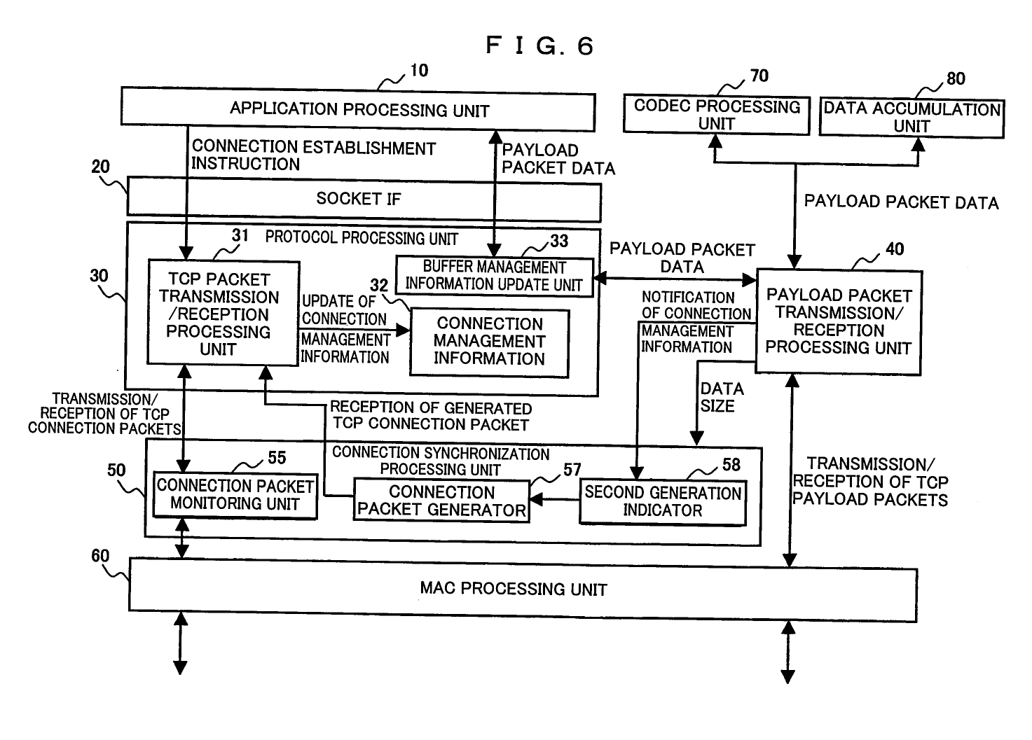

FIG. 6 is a block diagram showing a configuration of a TCP packet communication device according to Fifth Embodiment of the present invention. In FIG. 6, the same reference symbols as those shown in FIG. 5 (Fourth Embodiment) denote the same constituent elements as those shown in FIG. 5, respectively. The TCP packet communication device according to Fifth Embodiment characteristically includes a second generation indicator 58 in place of the first generation indicator 56. The second generation indicator 58 receives a data size notified from the payload packet transmission/reception processing unit 40, and compares the received data size with a preset data size threshold. If the received data size exceeds the threshold, the second generation indicator 58 notifies the connection packet generator 57 of update timing. Since the other configurations of the TCP packet communication device according to Fifth Embodiment are similar to those according to Fourth Embodiment, they will not be described herein.

As compared with Fourth Embodiment, Fifth Embodiment exhibits the following advantages. A configuration for performing synchronization processing on the connection management information 32 based on an amount of received data and with frequency following up a band of a communication line can be easily realized. As a result, the application processing unit 10 can always transmit management information packets via the protocol processing unit 30 through the socket IF 20 whenever receiving data having a constant data size. The configuration of the TCP packet communication device according to Fifth Embodiment characterized as stated above is suited for use as, for example, a device performing fast-forward replay or rewind replay of received video pictures.

### Sixth Embodiment

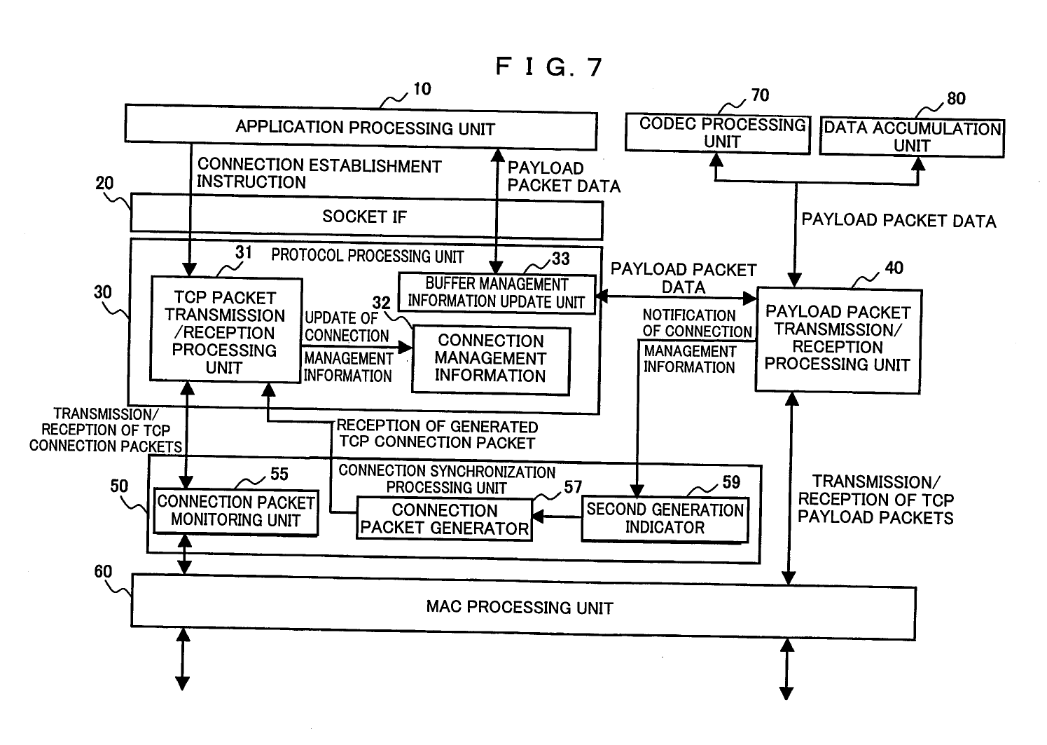

FIG. 7 is a block diagram showing a configuration of a TCP packet communication device according to Sixth Embodiment of the present invention. In FIG. 7, the same reference symbols as those shown in FIG. 5 (Fourth Embodiment) denote the same constituent elements as those shown in FIG. 5, respectively. The TCP packet communication device according to Sixth Embodiment characteristically includes a third generation indicator 59 in place of the first generation indicator 56. The third generation indicator 59 notifies the connection packet generator 57 of update timing at preset time intervals. Since the other configurations of the TCP packet communication device according to Fifth Embodiment are similar to those according to Fourth Embodiment, they will not be described herein.

As compared with Fourth Embodiment, Sixth Embodiment exhibits the following advantages. By reducing or adjusting load accompanied by the update of the connection management information 32 according to processing performance of the processor and a system load state, it is possible to improve real time performance for video processing and other application processing by a user interface or the like.

While the above-stated communication is normally realized by a wireless or wired communication device, the communication can be realized by a broadcasting receiver.

While the present invention has been described so far with reference to most preferred embodiments, combinations and arrangement of constituent elements in the most preferred embodiments can be variously changed without departure from the spirit and the scope of the present invention as defined in claims that follow.

What is claimed is:

1. A TCP packet communication device comprising:
a protocol processing unit for processing a packet used for connection establishment according to TCP/IP based on management information on the connection establishment, and processing a packet used for payload transmission;
a payload packet transmission/reception processing unit having a hardware configuration for performing transmission/reception processing on the packet used for the payload transmission based on the management information; and
a connection synchronization processing unit for performing synchronization processing for synchronizing the management information held by the protocol processing unit with the management information held by the payload packet transmission/reception processing unit.

2. The TCP packet communication device according to claim 1, wherein
the connection synchronization processing unit further includes a management information update unit for directly updating the management information in the protocol processing unit.

3. The TCP packet communication device according to claim 2, wherein
the connection synchronization processing unit further includes a first update indicator for setting an update timing of the management information at regular intervals, and
the management information update unit updates the management information at the update timing set by the first update indicator.

4. The TCP packet communication device according to claim 2, wherein
the connection synchronization processing unit further includes a second update indicator for setting an update timing of the management information whenever a packet is received, and
the management information update unit updates the management information at the update timing set by the second update indicator.

5. The TCP packet communication device according to claim 2, wherein
the connection synchronization processing unit further includes a third update indicator for setting an update timing of the management information whenever one of a FIN packet and an RST packet is received, and
the management information update unit updates the management information at the update timing set by the third update indicator.

6. The TCP packet communication device according to claim 1, wherein
the connection synchronization processing unit further includes
a connection packet monitoring unit for acquiring information necessary for the synchronization processing on the management information by referring to a content of each of the packets input to the protocol processing unit; and
a connection packet generator for altering each of the packets output from the protocol processing unit by referring to the information acquired by the connection packet monitoring unit.

7. The TCP packet communication device according to claim 6, wherein
the connection synchronization processing unit further includes a first generation indicator for setting a packet alteration timing of the connection packet generator at intervals of packet reception, and
the connection packet generator alters the output packet at the packet alteration timing set by the first generation indicator.

8. The TCP packet communication device according to claim 6, wherein
the connection synchronization processing unit further includes a second generation indicator for setting a packet alteration timing of the connection packet generator whenever the output packet has a specific data size, and
the connection packet generator alters the output packet at the packet alteration timing set by the second generation indicator.

9. The TCP packet communication device according to claim 6, wherein
the connection synchronization processing unit further includes a third generation indicator for setting a packet alteration timing of the connection packet generator at predetermined time intervals, and
the connection packet generator alters the output packet at the packet alteration timing set by the third generation indicator.

10. The TCP packet communication device according to claim 1, further comprising:
a buffer management information update unit for fetching a packet used for the payload transmission from the payload packet transmission/reception processing unit, directly supplying the packet used for the payload transmission to an internal buffer of the protocol processing unit, and updating the management information, wherein
the protocol processing unit performs a packet processing using an ordinary interface.

11. A video receiver comprising:
the TCP packet communication device according to claim 1; and
a codec processing unit for compressing and decompressing video data and voice data, wherein
the packet processed by the payload packet transmission/reception processing unit and used for the payload transmission is directly input to the codec processing unit.

12. A data accumulation device comprising:
the TCP packet communication device according to claim 1; and
a codec processing unit compressing and decompressing video data and voice data, wherein
the packet processed by the payload packet transmission/reception processing unit and used for the payload transmission is directly input to the data accumulation unit.
